(19) United States
(12) Patent Application Publication
(10) Pub. No.: US 2016/0226708 A1
(43) Pub. Date: Aug. 4, 2016

(54) ASSIGNING CLIENT DEVICES TO POINT-OF-PRESENCE CENTERS

(71) Applicant: LinkedIn Corporation, Mountain View, CA (US)

(72) Inventors: Ritesh Maheshwari, Mountain View, CA (US); Haricharan Ramachandra, Fremont, CA (US); Badrinath Sridharan, Saratoga, CA (US)

(21) Appl. No.: 14/610,444

(22) Filed: Jan. 30, 2015

(51) Int. Cl. H04L 12/24

(52) U.S. Cl. CPC H04L 41/0816; H04L 41/0893

(57) ABSTRACT

Techniques for reassigning client devices to different POP centers are provided. Client devices execute code that causes the client devices to request data from one or more POP centers. The client device record how much time it takes to receive the requested data. The download time is reported and aggregated to determine POP center-to-client device assignments. If it is determined that a client device should be reassigned to a particular POP center, then a DNS provider is configured to update the appropriate hostname-to-IP address mapping to an IP address of the particular POP center. A change in performance based on a POP reassignment may then be determined.

### FIELD OF THE DISCLOSURE

The present disclosure relates to point-of-presence (POP) centers and, more particularly, to assigning client devices to certain POP centers based on client-generated measurement data.

### BACKGROUND

A point-of-presence (POP) center is a small-scale data center with network equipment and proxy servers. A POP center acts as an end-point for a client device's TCP connection requests. A POP center establishes and holds a connection with a client device while the POP center retrieves at least a portion of the user-requested content from a data center.

A fast connection to a POP center usually translates into a good (or fast) “site speed” of a web site that is supported by the POP center. Typically, the closer a client device is to a POP center, the faster the connection to that POP center. Thus, if a web site owner desires to increase his/her site speed, the web site owner should assign POP centers to client devices that are close to the client devices. However, the relationship between geographic distance from a POP center and connection speed is more complicated. Multiple factors other than geographic distance may affect connection speed, making the decision how to assign POP centers more difficult.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is block diagram that depicts a system for tracking POP center response times, in an embodiment;

FIG. 2 is a sequence diagram that depicts different parts of a total page download time metric, in an embodiment;

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein for assigning client devices to POP centers. The assignment of a group of client devices to a POP center is based on measurement data received from multiple client devices. The measurement data may indicate how long it takes for a client device to download content from one or more POP centers. For a particular set of one or more client devices, a POP center that is associated with faster download times than other POP centers may be assigned to the particular set.

### System Overview

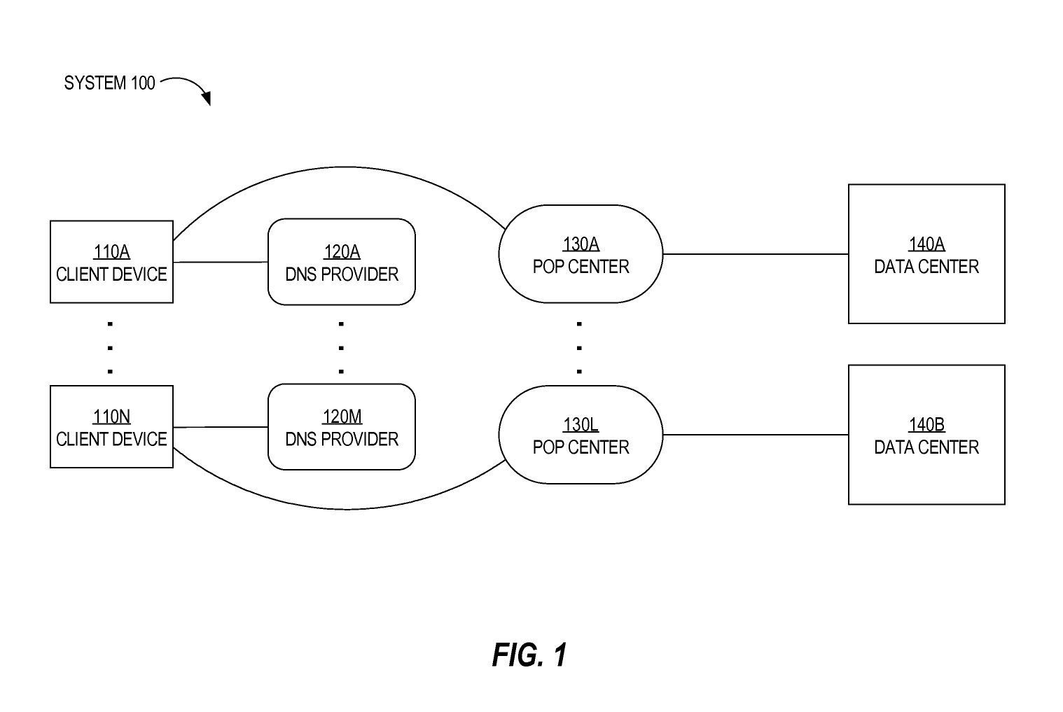

FIG. 1 is a block diagram that depicts a system 100 for tracking POP center response times, in an embodiment. System 100 includes client devices 110A-110N, DNS providers 120A-120M, POP centers 130A-130L, and data centers 140A-140B. Although two data centers 140A-140B are shown, embodiments include a single data center or more than two data centers.

Each of POP centers 130A-130L is configured to communicate with one or more of data centers 140A-140B. Each of POP centers 130A-130L and data centers 140A-140B is configured to provide content for the same web domain, such as www.linkedin.com. Thus, POP centers 130A-130L and data centers 140A-140B may be provided (or owned or managed) by the same entity.

Data centers 140A-140B also act as POP centers. In other words, client device 110A may connect directly with data center 140A instead of connecting indirectly with data center 140A through one of POP centers 130A-130L.

Each of client devices 110A-110N (or browsers executed thereon) is configured to send a DNS request to one of DNS providers 120A-120M. A DNS request includes a hostname. Each of DNS providers 120A-120M is configured to respond to DNS requests with DNS responses, each of which includes an IP address that is associated with the hostname. DNS providers 120A-120M may provide different IP addresses in response to DNS requests with the same particular hostname. For example, (1) DNS provider 120A may provide, in response to DNS requests for hostname www.cooldomain.com, an IP address of POP center 130A, and (2) DNS provider 120M may provide, in response to DNS requests for hostname www.cooldomain.com, an IP address of POP center 130L. In this way, different client devices may be directed to connect to different POP centers associated with the same domain. Thus, DNS providers 120A-M may allow domain owners to configure name servers to give different DNS answers based on a user's (or a client device's) geographic location.

Although not depicted in FIG. 1, each of client devices 110A-110N may be configured to send a DNS request to a DNS resolver that maintains a mapping of hostnames and IP addresses. If the DNS resolver does not have a mapping for a requested hostname, then the DNS resolver will forward the DNS request (or at least the hostname) to one of DNS providers 120A-120M. The DNS resolver may be configured to store each hostname-IP address mapping for a limited amount of time before the mapping needs to be refreshed or updated.

Although FIG. 1 depicts client device 110A and client device 110N as communicating (directly or indirectly) with only a single DNS provider 120, each of client devices 110A and 110N may communicate with multiple DNS providers 120 at different times. For example, DNS provider 120A may go offline or become otherwise unresponsive to DNS requests, after which a DNS request from client device 110A may be forwarded to DNS provider 120M.

Similarly, although FIG. 1 depicts client device 110A and client device 110N as connecting to only a single POP center 130, each of client devices 110A and 110N may connect to multiple POP centers 130 at different times. For example, POP center 130A may go offline or become otherwise unresponsive to client requests, after which a client request from client device 110A may connect to POP center 130L. As another example, at one time, DNS provider 120A sends an IP address of POP center 130A to client device 110A. At a later time, DNS provider 120A sends an IP address of POP center 130L to client device 110A.

Similarly, although FIG. 1 depicts POP center 130A and POP center 130L as connecting to only a single data center 140, each of POP centers 130A and 130L may communicate with multiple data centers 140. For example, data center 140A may go offline or become otherwise unresponsive, after which POP center 130A may communicate with data center 140B.

Additionally, data centers 140A and 140B may communicate with each other in response to a single client request. For example, data center 140B may include a service that is not provided in data center 140A but that is needed to process a client request.

### Response Data

Client devices 110A-110N generate response data regarding requests that are directed to POP centers 130A-130L and/or data centers 140A-140B. Response data is generated by code executing on client devices 110A-110N. The code may execute within a web browser of each client device.

Each instance of response data from a client device may comprise one or more response records. Each response record identifies a client device (such as a MAC address and/or IP address) and includes performance data, such as one or more of connection time, first byte time, or page download time, each of which is described in detail below.

A response record may also include information about the client device that generated the response record, such as the type of client device (e.g., smartphone, tablet, desktop), the manufacturer of the client device, the operating system on which the client device runs, the web browser that is used to connect to a POP center, and whether (and/or what type of) security was used to make the connection.

A response record may also include location data (e.g., geographic coordinates, a mailing address, a country name, or a time zone), time data (e.g., year, month, day, and/or time of day).

The code that executes on a client device to collect response data may be configured to determine when a user provides input that initiates a request for data provided by the web site. For example, the code may keep track of when a user selects an “Enter” key on a keyboard or a “Go” button in a graphical user interface (GUI).

### Total Page Download Time

As noted previously, performance data may include one or more measurements, such as connection time, first byte time, and page download time. Together, these three measurements make up a “total page download time.” In other words, the total page download time of loading a particular web page is the sum of the connection time, the first byte time, and the page download time.

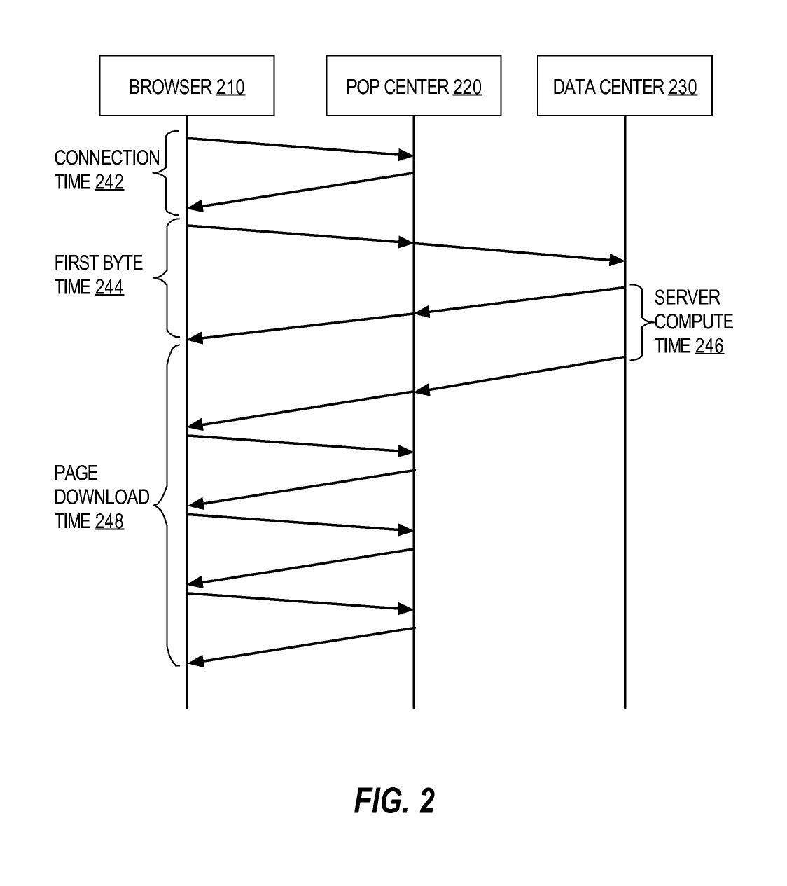

FIG. 2 is a sequence diagram that depicts different parts of the total page download time metric, in an embodiment. Browser 210 initiates a connection request at a time that begins connection time 242. Connection time 242 refers to a period of time instead of a single point in time. Connection time 242 may begin when a user submits a request for a URL of a web site. The connection request may be a TCP request and is received by POP center 220, which responds with connection information that is used for the TCP connection between browser 210 and POP center 220, such as a pseudo random sequence number. The receipt by browser 210 of the connection information from POP center 220 is the end of connection time 242.

First byte time 244 is also a period of time, which begins when browser 210 sends a request for data, for example, pertaining to a web page. POP center 220 receives the data request and forwards the data request to data center 230, which stores and maintains data that client devices might request. POP center 220 also has an existing “fast” connection with data center 230, which responds to the data request by sending at least a portion of the requested data. For example, data center 230 may send the head of an HTML document to POP center 220, which forwards the head to browser 210. First byte time 244 ends when browser 210 receives the portion (such as the first byte or the first set of bytes corresponding to header information) of the requested data.

Server compute time 246 is a period of time that begins when data center 230 transmits the first byte of requested data to POP center 220 and ends when data center 230 sends the last byte of requested data to POP center 220. If the requested content is a web page, then server compute time 246 involves data center 230 building the rest of the requested web page and sending the web page to POP center 220 as the web page is assembled. Because the web page is sent on an existing TCP connection (i.e., between POP center 220 and data center 230), the TCP connection may have large TCP congestion windows. Thus, it is possible that the entire web page is sent in one round trip time (RTT).

Page download time 248 is a period of time that begins when browser 210 receives the “first byte” of the requested data from POP center 220 and continues until browser 210 receives the last byte of the requested data from POP center 220. As FIG. 2 illustrates, a single transmission of data from data center 230 to POP center 220 may result in multiple round trips between browser 210 and POP center 220, especially if the requested content is relatively significant in size. Specifically, as POP center 220 receives the web page, POP center 220 relays the web page packet by packet to browser 210. If the TCP connection between POP center 220 and browser 210 is not a long-lived connection, then the congestion windows of the TCP connection are much smaller. Consequently, multiple RTTs would be needed to finish serving the requested web page to browser 210. For client devices with a high RTT to data center 230, POP center 220 helps improve the overall download time by reducing the RTT between client devices and POP center 220.

While FIG. 2 implies that the entirety of requested content comes from data center 230, a portion of the requested content may come from another source, such as a content delivery network (CDN) that is separate from data center 230. For example, data center 230 may serve dynamic content (e.g., Hypertext Markup Language (HTML) files and JavaScript Object Notation (JSON) files) while one or more CDNs may be configured to serve static assets, such as Cascading Style Sheets (CSS) files, JavaScript files, and images.

### Download Measurements

In an embodiment, a web page from a particular web site includes “POP measurement code” that, when executed by a client device, performs multiple actions in order to determine one or more download measurements with respect to one or more POP centers. The actions may be performed after the web page has been loaded onto the client device. The actions should have no discernable impact on user experience. Thus, end-users help improve their site experience by downloading POP measurement code that performs non-intrusive measurements when the end-users visit the particular web site.

POP measurement code may comprise: (1) timer code that starts a timer; (2) calling code that requests (e.g., using an Asynchronous JavaScript and XML (AJAX) request) content, such as an object, from a POP center; and (3) recording code that stops the timer when the content is completely downloaded, records the duration, and adds to response data (such as a first byte time and a page download time).

In an embodiment, each web page that is downloaded from one of data centers 140A-140B to a client device 110 includes POP measurement code. In an alternative embodiment, only some web pages include POP measurement code. For example, only 1% of requested web pages include the POP measurement code.

In an embodiment, POP measurement code indicates multiple POP centers 130. For example, all POP centers 130A-L of a particular domain are indicated in measurement code. Thus, a client device that executes the POP measurement code will download data from each of POP centers 130A-130L.

For example, download measurements from client device 110A may indicate the following:
1.32 milliseconds from POP center 130A
3.28 milliseconds from POP center 130L.
   Download measurements from client device 110N may indicate the following:
2.91 milliseconds from POP center 130A
1.07 milliseconds from POP center 130L.

Alternatively, POP measurement code includes a strict subset of all known POP centers of the particular domain. For example, POP measurement code that is sent to client device 110A does not indicate POP center 130L and POP measurement code that is sent to client device 110N does not indicate POP center 130A. As another example, the set of POP center identities that are included in an instance of measurement code depends on where the target client device is located. For example, client devices that are located in the United States (which may include one or more POP centers) will not receive POP measurement code that indicates POP centers that are located in Europe or Asia.

POP measurement code may be distributed to client devices 110A-110N on a regular basis or during certain times, referred to as “measurement campaigns.” A “measurement campaign” involves distributing POP measurement code for a period of time, collecting download measurements, and updating existing POP assignments. Thus, there may be periods of time (e.g., days, weeks, or months) when POP measurement code is not distributed to any client device. Therefore, download measurements are not collected during such time periods.

Each of client devices 110A-110N that executes POP measurement code determines and reports one or more download measurements to a data analyzer (not depicted). The data analyzer may reside within one of data centers 140A-140B or within one of POP centers 130A-130L. The data analyzer is implemented in software, hardware, or a combination of software and hardware. The data analyzer configured to analyze download measurements that are generated and reported by client devices 110A-110N. While different computing components may perform the steps of receiving download measurements, analyzing the download measurements, and assigning POP centers 130A-130L to different sets of client devices 110A-110N, the following description refers to the data analyzer performing each of these steps.

### Pop-to-Region Assignments

In an embodiment, client devices are grouped into regions. A region may be a geographic region or a non-geographic region. Examples of geographic regions include a country, a state, a province, or other geographic regions that are defined by political boundaries. Examples of geographic regions that do not correspond to political boundaries include the Mountain West, the Pacific Northwest, the African continent, the Amazon, the Nile Delta, the Central Plains, etc. Such regions may be specified based on user input.

Examples of non-geographic regions include autonomous systems (uniquely identified by autonomous system number (ASN)), network service providers, etc.

Client devices throughout the world may be grouped into (or assigned to) geographic regions, non-geographic regions, or both. Thus, some client devices may be part of a geographic region and other client devices may be part of a non-geographic region.

Therefore, in an embodiment, download measurements are aggregated based on a region to which a client device is assigned. If download measurements from the same client device indicate download times with respect to multiple POP centers, then download measurements may be first segregated based on the region to which the client device is assigned and then based on POP center.

For example, after receiving the download measurement from client device 110A, the data analyzer may first determine, based on a device-to-region mapping, that client device 110A belongs to region X. A data set (e.g., a table) associates region X with multiple POP centers 130A-130L. For example, each row in a table for region X corresponds to a different POP center. One of the fields in the table corresponds to an aggregate (e.g., average or median) download time. Thus, the data analyzer determines, for each download measurement from client device 110A, which aggregated download time (in the table) to update based on the appropriate download measure. For example, if the average download time for POP center 130A is 1.57 milliseconds and another download time from client device 110A indicates a download time of 1.32 milliseconds with respect to POP center 130A, then the average download time is updated based on the 1.32 millisecond measurement. In this scenario where an average download time is maintained, a count that indicates a number of download measurements that are reflected in the average download time may be stored in association with the corresponding POP center so that future download measurements (that are received from client devices that are assigned to the same region as client device 110A) regarding POP center 130A may be aggregated or combined appropriately with the existing average download time.

Alternatively, instead of serially aggregating each download measurement as it is received from a client device, each download measurement for a particular POP center is distinctly stored and aggregated once (or at different times).

Thus, download measurements may be aggregated on a per-region and per-POP center basis. For example, download measurements regarding POP center A received from client devices that are assigned to Country X are aggregated to determine an average or median download time with respect to POP center A while download measurements regarding POP center B received from client devices that are assigned to Country X are aggregated to determine an average or median download time with respect to POP center B.

### Pop-to-Client Assignments

In an embodiment, a POP center is assigned to a specific client device (or IP address) or to client devices that are associated with an IP address in a specific set of IP addresses. Thus, instead of assigning a single POP center to a large group of client devices (e.g., all client devices in China), client devices are dealt with on a more granular level. For example, under the POP-to-region approach, client devices in Xining, China and in Shanghai, China may be assigned to the same POP center (because both sets of client devices are located in the same country or region). Under the POP-to-client approach, client devices in Xining, China may be assigned to a POP center in India while client devices in Shanghai, China may be assigned to a POP center in Hong Kong. As another example, different client devices in the same city may be assigned to different POP centers.

### Identifying Optimal Assignments

After multiple download measurements are aggregated (whether on a per-region or a per-client basis), a POP center associated with the lowest aggregated download time (with respect to a region or a specific client device) may be selected. For example, Country X is associated with the following five aggregated (average, median, or other percentile) download times:
POP center A: 1.12 milliseconds
POP center B: 5.07 milliseconds
POP center C: 6.34 milliseconds
POP center D: 3.91 milliseconds
POP center E: 2.66 milliseconds

Because POP center A is associated with the lowest aggregated download time (with respect to Country X), POP center A is assigned to client devices that are located in (or otherwise associated with) Country X. Depending on aggregated download times of client devices of other regions, POP center A may be assigned to client devices of one or more other regions.

### Weighting Download Times

Simply choosing the lowest aggregated download times associated with different POP centers may not result in an optimal assignment. For example, the POP center associated with the lowest aggregated download time may be POP center 130A (which requires a connection with one of data centers 140A or 140B) while the POP center associated with the second lowest aggregated download time may be data center 140A. As another example, some POP centers may be known to have a slow connection with a data center relative to other POP centers. As another example, some POP centers, while typically associated with relatively fast download or connection times, may go offline or become unavailable more often than other POP centers.

In an embodiment, an aggregated download time is weighted based on one or more criteria. A weighting factor effectively favors one POP center over one or more other POP centers. For example, an aggregated download time for a particular POP center may be multiplied by a weighting factor (e.g., 0.9) prior to comparing the download time for the particular POP center with aggregated download times of other POP centers.

Another example of a weighting factor is a latency between a POP center and a data center to which the POP center is connected. If a POP center is not a data center, then a connection time between the POP center and a data center is added to the aggregated download time associated with the POP center. For example, if (1) the aggregated download time of POP center 130A with respect to region X (to which client device 110A belongs) is 1.32 milliseconds, (2) and the aggregated download time of data center 140A with respect to region X is 1.44 milliseconds and (3) the (e.g., average or median) latency between POP center 130A and data center 140A is 0.63 milliseconds, then 0.63 milliseconds is added to 1.32 milliseconds to become 1.95 milliseconds. Therefore, even though the average download time between client devices in region X and data center 140A is greater than the average download time between client devices in region X and POP center 130A, it is better for client devices in region X to connect directly to data center 140A due to the latency between POP center 130A and data center 140A.

The latency between a POP center and a data center may be determined based on a single measurement or multiple measurements that are aggregated in some fashion, such as an average, a median, or some other percentile.

If there are multiple regions (or client devices) that have aggregated download times for a POP center that is not a data center, then each of the aggregated download times may be updated to include a latency between the corresponding POP center and the corresponding data center.

### Configure DNS Providers

In an embodiment, if it is determined that a region (or client device) should be reassigned to a particular POP center that is different than the one to which the region (or client device) is currently assigned, then a “reassignment” is initiated. A reassignment may involve sending, to one or more of DNS providers 120A-120M, configuration data that indicates a hostname and a “new” IP address, i.e., of the particular POP center. The sending may be performed by a computing device located inside (or outside) one of data centers 140A-140B. The computing device may be owned or managed by the same entity that owns the web content provided by data centers 140A-140B.

In response to receiving the configuration data, each of the one or more DNS providers updates, based on the hostname indicated in the configuration data, the appropriate hostname-to-IP address mapping to replace the IP address of the previously-assigned POP center with the “new” IP address, i.e., of the particular POP center. Thereafter, each of the one or more DNS providers will respond to DNS requests that include the hostname with the “new” IP address.

### Analyzing Performance after Reassignment

In an embodiment, a change in network performance for a client device (or a group of client devices) after a POP reassignment is determined. In order to determine any change, (1) the POP center that provided a requested web page before the reassignment (the “previous POP center”) is identified and (2) the POP center that provided a requested web page after the reassignment (“the subsequent POP center”) is identified.

However, a POP center is selected at DNS resolution time based on a client device's geographical location. Because response data is generated on a client device based on code executing in a web browser, the executed code cannot do a direct DNS resolution to identify which POP center served a page view. However, executable code (e.g., JavaScript) is able to read response headers of (e.g., AJAX) calls that the executable code initiated.

Therefore, in an embodiment, each of POP centers 130A-130L is configured to add, to a data packet that is sent to a client device, a response header that uniquely identifies the POP center relative to the other POP centers. The client device, when reporting response data regarding a requested web page, includes not only performance data (such as connection time 242, first byte time 244, and/or page download time 248), but also POP identification data that identifies the POP center that served the requested web page.

The data packet that includes POP identification data may be one that the POP center generates in response to a (e.g., AJAX) request from a client device. The request may be generated and sent by the client device after a requested web page is loaded. The request is sent to the same POP center that served the requested web page due to the way DNS providers are configured.

After response data that is supplemented with POP identification data is received, the data analyzer uses the POP identification data to determine whether certain traffic (e.g., client requests from client devices in region X) is actually going through the currently-assigned POP center. If not, then the appropriate DNS providers may need to be reconfigured or other measures taken to determine why the POP reassignment was not completed.

Also based on the POP identification data, the data analyzer may determine whether a POP reassignment resulted in better performance for one or more client devices. For example, before a POP reassignment, client devices from region X had a median page download time of 1.23 seconds. After the POP assignment, client devices from region X had a median page download time of 0.97 seconds. Therefore, in this example, there is an improvement of approximately 21% in median page download time. In contrast, if it is determined that there is performance degradation after a POP reassignment for client devices from region X, then the DNS provider(s) that support the client devices of region X are configured to change the appropriate hostname-to-IP address mapping to indicate a different POP center, such as the POP center that was previously assigned to the client devices of region X. The determination of performance degradation and the subsequent reassignment may be performed automatically or may be initiated based on user input.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

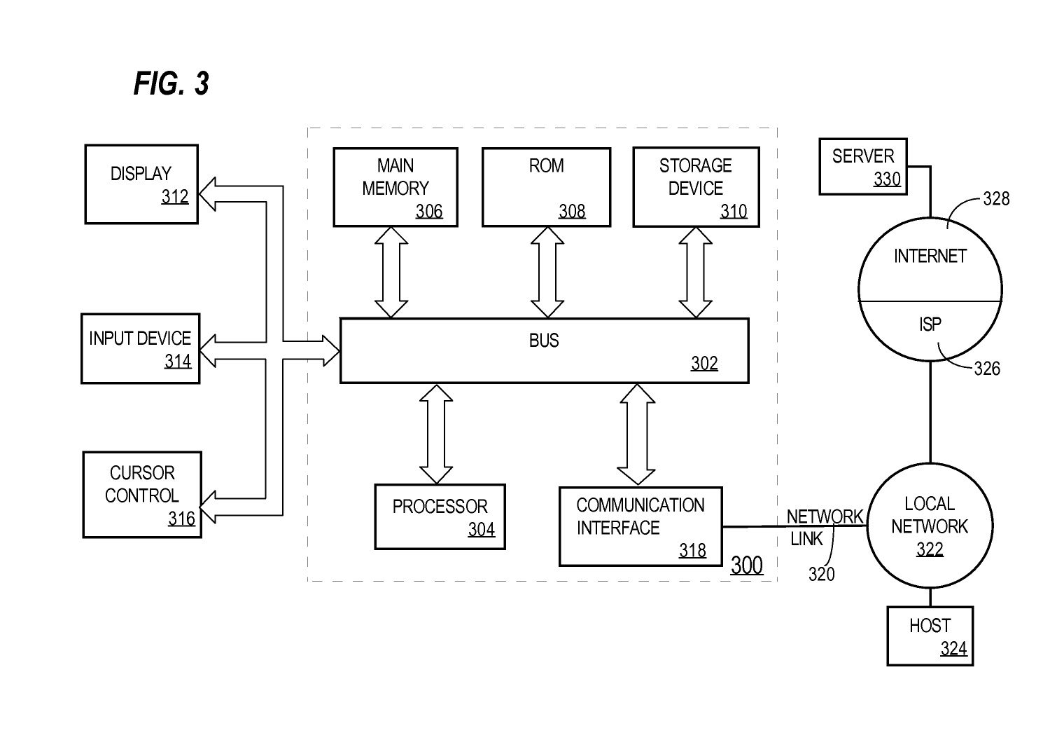

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, from a first client device, first response data that indicates a first response time between the first client device and a first point-of-presence (POP) center;
receiving, from a second client device that is different than a first client device, second response data that indicates a second response time between the second client device and a second POP center;
selecting, based on the first response data and a second response data, a particular POP center from among a plurality of POP centers that includes the first POP center and the second POP center;
causing the first client device and the second client device to connect to the particular POP center;
wherein the method is performed by one or more computing devices.

2. The method of claim 1, further comprising:
sending, to the first client device, code that, when executed by the first client device, causes the first client device to generate the first response data.

3. The method of claim 1, further comprising:
prior to selecting the particular POP center:
determining first aggregated measurement data that indicates a first time to download data from the first POP center to a first set of client devices;
determining second aggregated measurement data that indicates a second time to download data from the second POP center to a second set of client devices that includes one or more client devices in the first set of client devices;
wherein selecting the particular POP center comprises selecting the particular POP center based on the first time and the second time.

4. The method of claim 3, further comprising:
prior to selecting the particular POP center based on the first time and the second time, applying a weighting factor to the first time to generate the first modified time;
wherein selecting the particular POP center based on the first time and the second time comprises selecting the particular POP center based on the first modified time and the second time.

5. The method of claim 4, wherein applying the weighting factor to the first time comprises:
determining a latency between the first POP center and a data center that is different than the first POP center;
wherein the weighting factor is the latency;
adding the latency to the first time to generate the first modified time.

6. The method of claim 1, further comprising, prior to selecting the particular POP center, determining that the first client device and the second client device belong to a particular set of client devices that both satisfy one or more criteria.

7. The method of claim 6, wherein the one or more criteria includes the particular set of client devices belonging to the same country.

8. The method of claim 1, wherein:
the first response data comprises a plurality of response times;
each response time of the plurality of response times indicates a time for data to travel between the first client device and a different POP center of multiple POP centers.

9. The method of claim 1, wherein:
the first response data includes identification data that identifies the first POP center;
the identification data was inserted, by the first POP center, into a response that the first POP center sent to the first client device.

10. The method of claim 1, wherein causing the first client device and the second client device to connect to the particular POP center comprises:
sending, to a DNS provider, configuration data that indicates a hostname of a web site and an IP address of the particular POP center, wherein the DNS provider, in response to receiving the configuration data, updates a mapping that associates the hostname with a second IP address to a mapping that associates the hostname with the IP address of the particular POP center.

11. The method of claim 1, further comprising, after causing the first client device and the second client device to connect to the particular POP center:
storing first performance data that indicates one or more first performance metrics regarding a set of one or more client devices with respect a certain POP center that is different than the particular POP center;
storing second performance data indicates one or more second performance metrics regarding the set of one or more client devices with respect to the particular POP center;
comparing the first performance data with the second performance data to determine a change in performance after an assignment of the particular POP center to the first client device and the second client device.

12. The method of claim 11, wherein the one or more first performance metrics include a connection time between the set of one or more client devices and the certain POP center, a first byte time between the set of one or more client devices and a data center associated with the certain POP center, or a page download time between the between the set of one or more client devices and the data center associated with the certain POP center.

13. A system comprising:
one or more processors;
one or more storage media storing instructions which, when executed by one or more processors, cause:
receiving, from a first client device, first response data that indicates a first response time between the first client device and a first point-of-presence (POP) center;
receiving, from a second client device that is different than a first client device, second response data that indicates a second response time between the second client device and a second POP center;
selecting, based on the first response data and a second response data, a particular POP center from among a plurality of POP centers that includes the first POP center and the second POP center;
causing the first client device and the second client device to connect to the particular POP center.

14. The system of claim 13, wherein the instructions, when executed by the one or more processors, further cause:
sending, to the first client device, code that, when executed by the first client device, causes the first client device to generate the first response data.

15. The system of claim 13, wherein the instructions, when executed by the one or more processors, further cause:
prior to selecting the particular POP center:
determining first aggregated measurement data that indicates a first time to download data from the first POP center to a first set of client devices;
determining second aggregated measurement data that indicates a second time to download data from the second POP center to a second set of client devices that includes one or more client devices in the first set of client devices;
wherein selecting the particular POP center comprises selecting the particular POP center based on the first time and the second time.

16. The system of claim 15, wherein the instructions, when executed by the one or more processors, further cause:
prior to selecting the particular POP center based on the first time and the second time, applying a weighting factor to the first time to generate the first modified time;
wherein selecting the particular POP center based on the first time and the second time comprises selecting the particular POP center based on the first modified time and the second time.

17. The system of claim 16, wherein applying the weighting factor to the first time comprises:
determining a latency between the first POP center and a data center that is different than the first POP center;
wherein the weighting factor is the latency;
adding the latency to the first time to generate the first modified time.

18. The system of claim 13, wherein the instructions, when executed by the one or more processors, further cause, prior to selecting the particular POP center, determining that the first client device and the second client device belong to a particular set of client devices that both satisfy one or more criteria.

19. The system of claim 18, wherein the one or more criteria includes the particular set of client devices belonging to the same country.

20. The system of claim 13, wherein:
the first response data comprises a plurality of response times;
each response time of the plurality of response times indicates a time for data to travel between the first client device and a different POP center of multiple POP centers.

21. The system of claim 13, wherein:
the first response data includes identification data that identifies the first POP center;
the identification data was inserted, by the first POP center, into a response that the first POP center sent to the first client device.

22. The system of claim 13, wherein causing the first client device and the second client device to connect to the particular POP center comprises:
sending, to a DNS provider, configuration data that indicates a hostname of a web site and an IP address of the particular POP center, wherein the DNS provider, in response to receiving the configuration data, updates a mapping that associates the hostname with a second IP address to a mapping that associates the hostname with the IP address of the particular POP center.

23. The system of claim 13, wherein the instructions, when executed by the one or more processors, further cause, after causing the first client device and the second client device to connect to the particular POP center:
storing first performance data that indicates one or more first performance metrics regarding a set of one or more client devices with respect a certain POP center that is different than the particular POP center;
storing second performance data indicates one or more second performance metrics regarding the set of one or more client devices with respect to the particular POP center;
comparing the first performance data with the second performance data to determine a change in performance after an assignment of the particular POP center to the first client device and the second client device.

24. The system of claim 23, wherein the one or more first performance metrics include a connection time between the set of one or more client devices and the certain POP center, a first byte time between the set of one or more client devices and a data center associated with the certain POP center, or a page download time between the between the set of one or more client devices and the data center associated with the certain POP center.
